(19) United States
(12) Patent Application Publication
(10) Pub. No.: US 2011/0283641 A1
(43) Pub. Date: Nov. 24, 2011

(54) Subflooring water and radon gas channeling system

(76) Inventor: David K. Aubut, Barre, VT (US)

(21) Appl. No.: 12/800,803

(22) Filed: May 24, 2010

(51) Int. Cl. E04B 1/92; H04Q 5/22; E04B 1/38

(52) U.S. Cl. 52/302.1; 52/698; 340/10.1

(57) ABSTRACT

A subflooring water and radon gas channeling system consisting of a plurality of elongated hollow channeling units with holes in each side thereof connected to one another on each side of a basement region of a building with ends of certain of such units being also connected to ends of each of a plurality of corner connector units with one channeling unit having a sensor through hole for receipt of a water level sensor and another through hole atop which is mounted a spout for receipt of one end of a hose and with all components resting on inner foundational footings located below basement flooring for purposes of beridding the building of water and radon gas.

### CROSS REFERENCES TO PRIOR OR PARENT APPLICATIONS

There are no prior or parent applications to which the instant invention relates. There was an application with application Ser. No. 11/267,372 filed with the U.S. Patent & Trademark Office by and on behalf of David K. Aubut on Nov. 7, 2005 but however subsequently abandoned.

### FEDERALLY SPONSORED RESEARCH AND DEVELOPMENT

The instant invention is not the subject of any federally sponsored research and development.

### BACKGROUND OF THE INVENTION

1. Field of the Invention

The instant invention relates to those devices serving to berid basement regions within buildings and occupied structures of water and radon gas.

2. Related Art

The herewith submitted Informational Disclosure Statement specifies art that does not however anticipate the instant invention.

### A SUMMARY OF THE INVENTION

### 1. A Brief Description of the Invention

The instant invention consists of a plurality of elongated first and second channeling units. Two channeling units are affixable to one of four corner connector units. Each corner connector unit respectively occupies one corner sector of a basement region of an occupied building or structure. The entire system rests on inner footings of a building foundation below the level of basement flooring. Each first channeling unit is hollow and semi-cylindrical in shape. Each such unit has a bottom side extending from the first end thereof to near the second end portion of each. The second end portion of each is also semi-cylindrical in shape but with an internal diameter slightly in excess of the internal diameter of the remaining length of the unit. The second end portion also lacking a bottom side serves to receive the first end of another first channeling unit or the first end of a second channeling unit. Second channeling units differ from first channeling units only in that no second channeling unit has a second end portion both lacking a bottom side and with an internal diameter in excess of the internal diameter of the remainder of the unit. All channeling units have a plurality of holes in each side thereof. Each connector unit is semi-cylindrically shaped and curved and with a bottom side except within either end portion thereof. The respective end portions of each corner connector unit are semi-cylindrical in shape as well but within an internal diameter in excess of the internal diameters of first ends of first channeling units and of either ends of second channeling units. One first channeling unit has a first topside through hole for receipt of a water level sensor unit extending down through the hole into the unit with the end of the sensor unit being located a short distance above the bottom side of the unit. The sensor unit extends upwardly through the first topside through hole and a hole in the basement flooring and is wired at a second end thereof to an alarm unit located on or above the flooring. The same channeling unit has a second topside through hole about which there is a mounted spout. The spout is elongated and also extends upwardly through another hole in the basement flooring. The system below the flooring is typically circumscribed by a medium such as crushed stone. Water and radon gas seep through the holes in the sides of the channeling units adjacent joint portions of the inner footings and subflooring foundational walling from whence the water and gas emanate and into the units and in turn then through the holes in the opposite sides thereof into the medium to then leach towards ultimately a subflooring pump unit serving to remove the water and/or gas from the medium. The sensor serves to activate the alarm unit if water levels within the channeling units get too high, a sign of perhaps pump malfunction. The spout typically covered by a hinged lid serves to receive a hose containing water under pressure whenever there is a perceived need to flush the system periodically to berid it of accumulated silt or debris.

### 2. Objects of the Invention

The purpose of the instant invention is to provide a safe, efficient and economically viable means for beridding a basement region of a building of otherwise accumulating water and/or radon gas. The semi-cylindrical shape of the components of the system serves to ensure overall systemic sturdiness. The sensor feature serves to ensure virtually a continuous functionality of the system. The spout feature facilitates virtually continuous functionality as well by providing a facility for continuous cleanliness of the overall system. The essential simplicity of design of the overall system combined with its sturdiness renders it essentially maintenance free.

Respectfully submitted, in view of the fact of the foregoing, the instant invention is truly useful along with being unquestionably new and unique.

### THE DRAWINGS

FIG. 1 is a top plan view of flooring of a basement region.

FIG. 2 is a top plan view of the invention nearly fully assembled resting on foundational inner footings.

FIG. 3 is a top plan view of the invention fully assembled and resting on foundational inner footings.

FIG. 4 is a perspective view of a portion of the nearly fully assembled invention resting on foundational inner footings.

FIG. 5 is a perspective view of the alarm and cleansing features of the invention.

FIG. 6 is a frontal view of what is shown in FIG. 5.

FIG. 7 is a perspective view of a first channeling unit.

FIG. 8 is a lateral plan view of the side of the first channeling unit opposite the side thereof shown in FIG. 7.

FIG. 9 is an end view of the first end of a first channeling unit.

FIG. 10 is a perspective view of a second channeling unit.

FIG. 11 is a lateral plan view of the side of the second channeling unit opposite the side thereof shown in FIG. 9.

FIG. 12 is an end view of one end of a second channeling unit.

FIG. 13 is a perspective view of a corner connector unit.

FIG. 14 is a top plan view of a corner connector unit.

FIG. 15 is a bottom plan view of a corner connector unit.

FIG. 16 is a view of a portion of the invention amidst a subflooring medium and evacuation system.

### A DESCRIPTION OF THE PREFERRED EMBODIMENTS

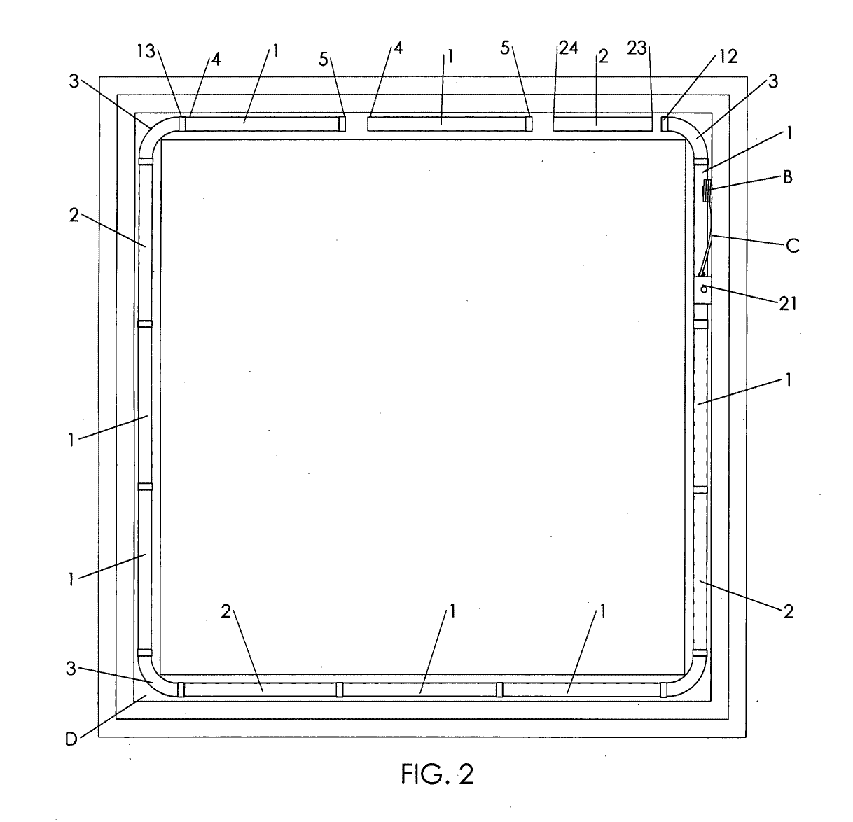

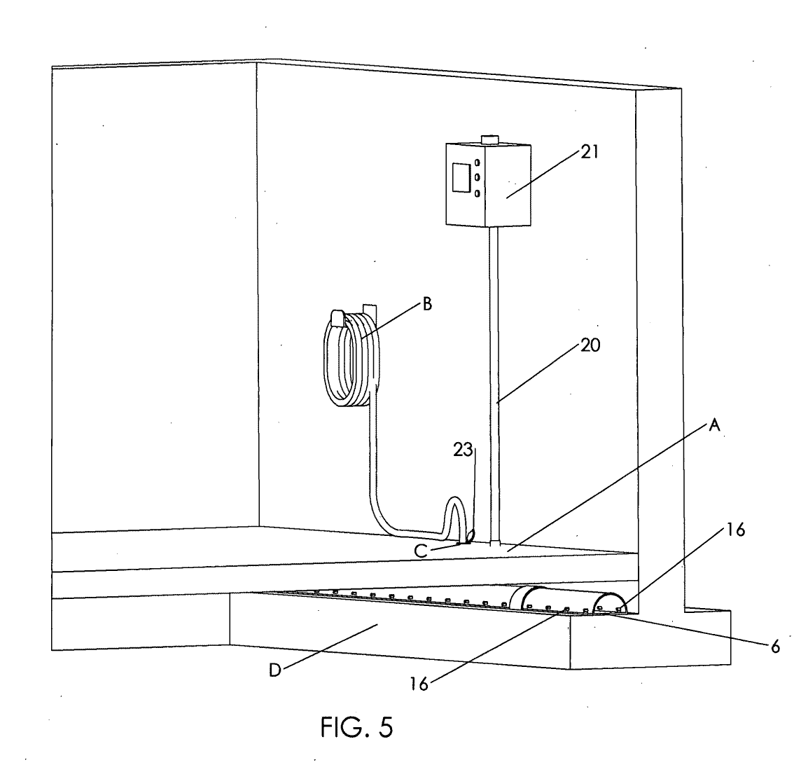

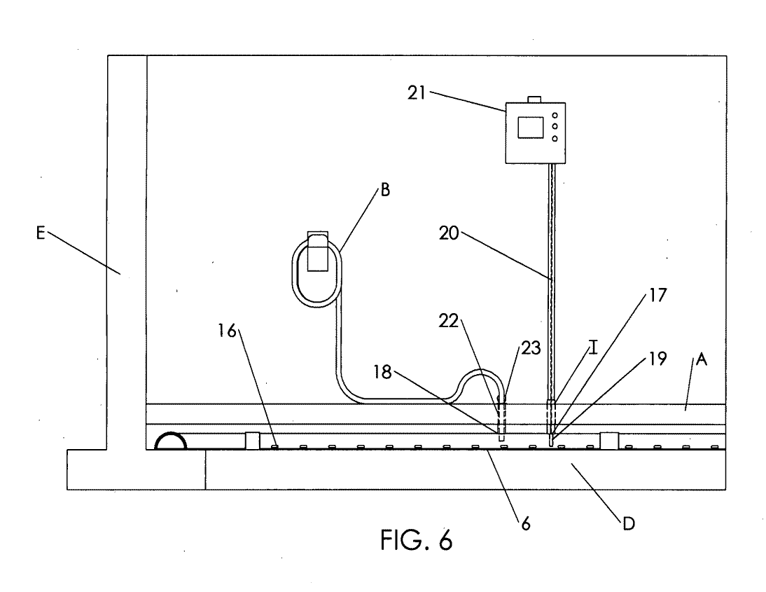

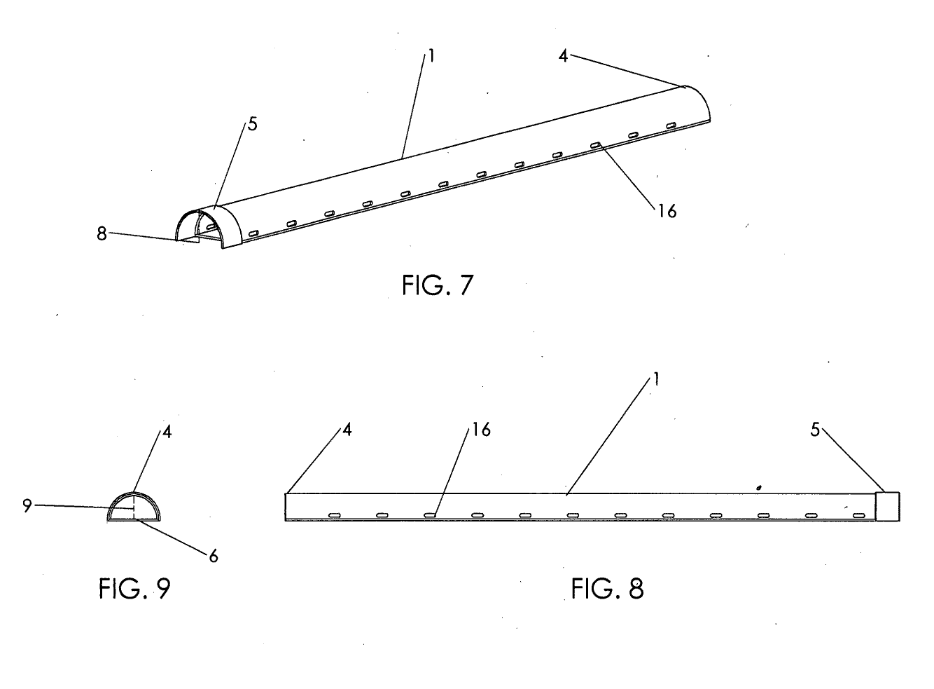

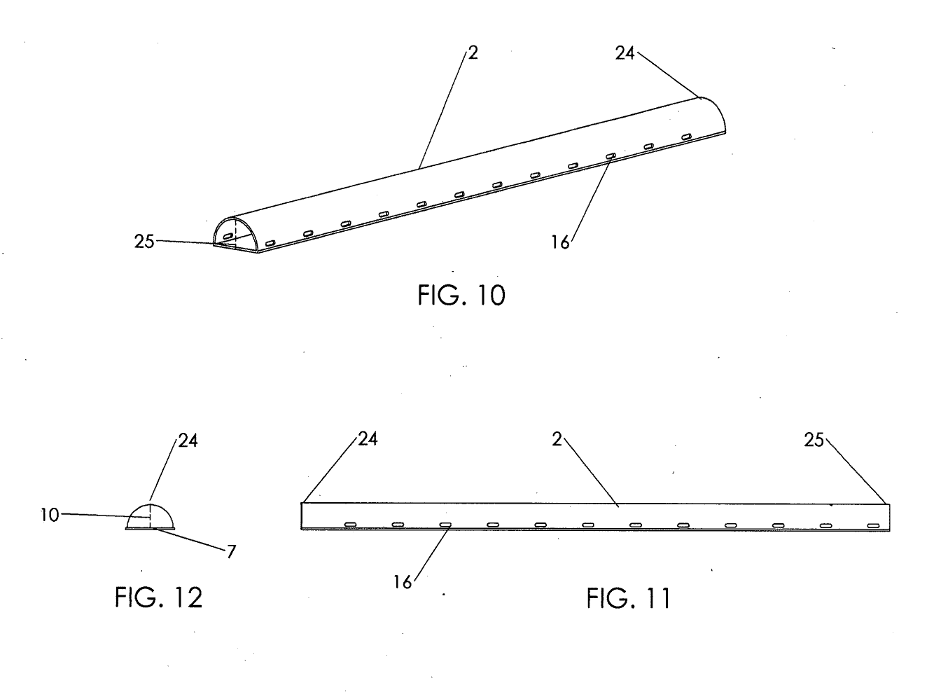

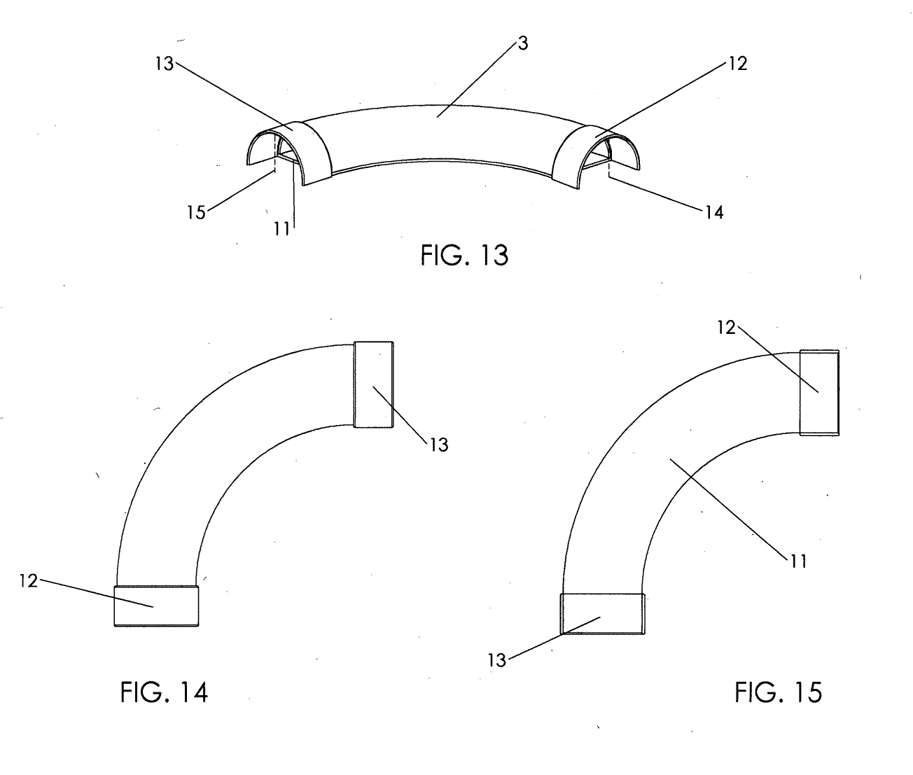

The invention consists of a plurality of elongated semi-cylindrically shaped, hollow first channeling units 1 as shown in FIG. 2. It also consists of a plurality of elongated, semi-cylindrically shaped, hollow second channeling units 2 as are also seen in FIG. 2. It further consists of a plurality, of typically four, curved, semi-cylindrically shaped hollow corner connector units 3 as shown in FIGS. 2, 13 and 14. Units 1, 2 and 3 are typically made up of sturdy, durable PVC (polyvinyl chloride) material, though the units could all be metallic as well. First channeling units 1 each have a first end 4 and a second end portion 5 as can be noted with resort to FIG. 7. First channeling units 1 all have a bottom side 6 extending from first end 4 of each to second end portion 5 of each as is shown in FIG. 7 and FIG. 9. Channeling units 2 each have a bottom side 7 extending from first end 24 to second end 25 of each as seen in FIGS. 10, 11 and 12. Second end portion 5 of each channeling unit 1 has a second end radius 8 that is greater in length than first channeling radius 9 of the remainder segment of each channeling unit 1 and second end radius 8 is also greater in length than second channeling radius 10 all as can be visualized with reference to FIGS. 7, 9 and 12 respectively. A bottom side 11 of each corner connector unit 3 extends from a first end sector 12 of each to a second end sector 13 of each as is shown in FIG. 15. A first radius 14 of first end sector 12 is equal in length to a second radius 15 of second end sector 13 as can be seen in FIG. 13. First radius 14 is greater in length than first channeling radius 9 and greater in length than second channeling radius 10. Holes 16 are located in both sides of each first channeling unit 1 and each second channeling unit 2 as can be seen in FIGS. 5, 7, 8, 10 and 11. A sensor through hole 17 and a separate cleansing through hole 18 are shown located in the uppermost midline of one of channeling units 1 in FIG. 6. A sensor device 19 affixed to elongated wiring 20 is shown in FIG. 6 extending through hole 17 into the lumen of the channeling unit 1 to a distance shortly above the bottom side 6 thereof also with reference to FIG. 6. Holes 17 and 18 could just as easily have been bored into a second channeling unit 2 instead of a first channeling unit 1. Wiring 20 extends upwardly through hole 17 and a hole I in basement flooring A to an alarm unit 21 as shown also in FIG. 6. The sensor system comprised of sensor 19 and wiring 20 and alarm unit 21 could be any system such as for example, a FLOOD-ALERT ALARM SENSOR system. An elongated spout 22 is mounted to the channeling unit 1 about cleansing hole 18 and extends upwardly through a hole C in basement flooring A as can be noted with reference to FIGS. 5 and 6. An optional lid 23 affixed to spout 22 is also shown in FIG. 5 and FIG. 6.

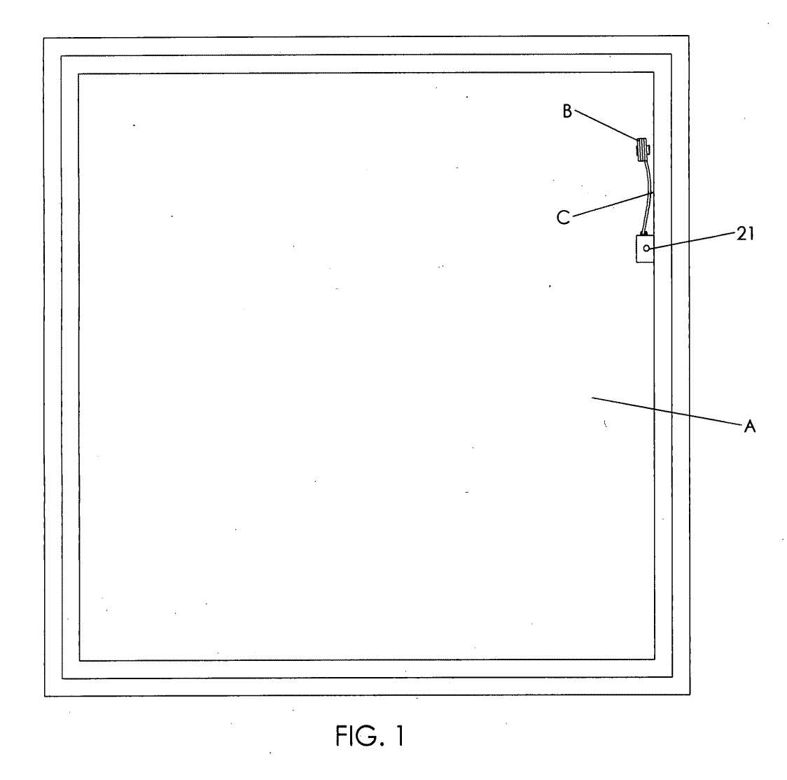

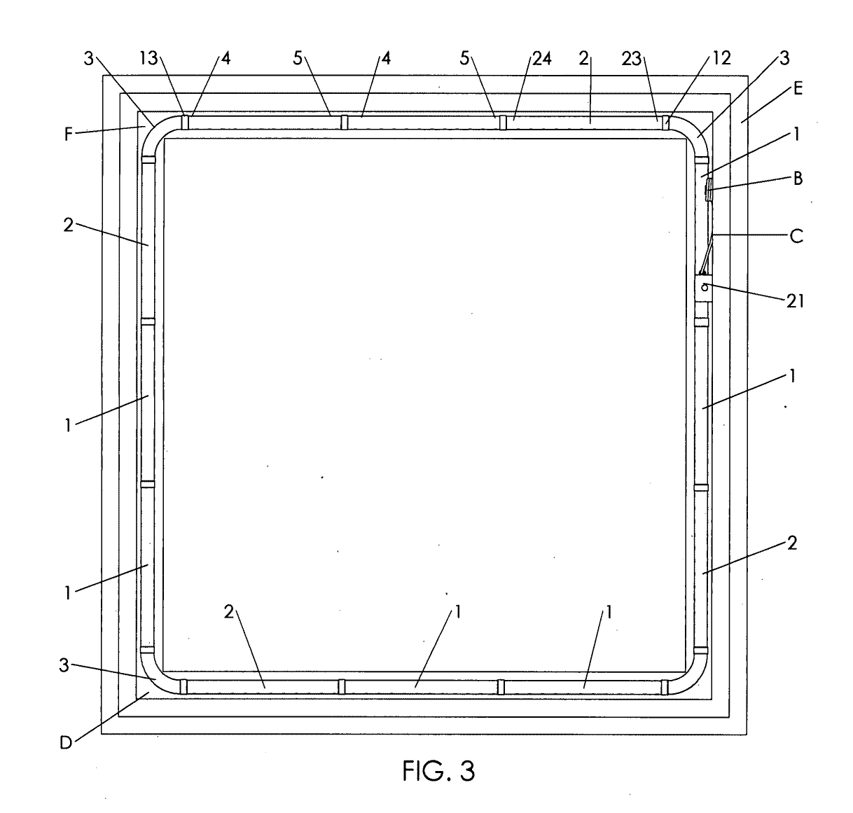

FIG. 1 is a top plan view of basement flooring A below which will be found the fully assembled invention resting on inner footings D as shown in FIG. 3. The invention is assembled as follows: I: As shown in FIG. 3, the first end 24 of each of four second channeling units 2 is connected to the first end sector 12 of each corner connector unit 3 atop inner foundation footing D. II: As shown per FIG. 2, the second end 25 of each of such second channeling unit 2 is then connected into the second end portion 5 of a first channeling unit 1. III: The first end 4 of each of the abovesaid first channeling units 1 are then connected into second end portions 5 of other first channeling units 1 as also shown in FIG. 2. IV: First ends 4 of such other first channeling units 1 are then connected into second end sectors 13 of corner connector units 3. If the length of footing D on each side of a basement is sufficiently long, then an additional group of first channeling units 1 may be required to fully assemble the invention as per step 1V above. Connectivity as noted above is readily accomplished by way of manufacturing units 1, 2 and 3 in such a manner that unit end regions characterized by radii 9 or 10 will fit snugly into unit end regions characterized by radii 8, 14 or 15.

The radii 14 and 15 of sectors 12 and 13 being greater in length than the radii 9 and 10 of the first channeling units 1 and the second channeling units 2 respectively as noted with reference to FIGS. 9, 12 and 13 coupled with the lack of a bottom side 11 within sectors 12 and 13 serve to facilitate ready connectivity as between corner connector units 3 and first ends 4 of first channeling units 1 and either first ends 24 or equivalent second ends 25 of channeling units 2. Similarly, the radius 8 of each second end portion 5 being greater than radii 9 and 10 serve to facilitate ready connectivity within second end portions 5, of first end 4 of another first channeling unit 1 or a first end 24 or a second end 25 of a second channeling unit 2 especially since each second end portion 5 also lacks a bottom side 6.

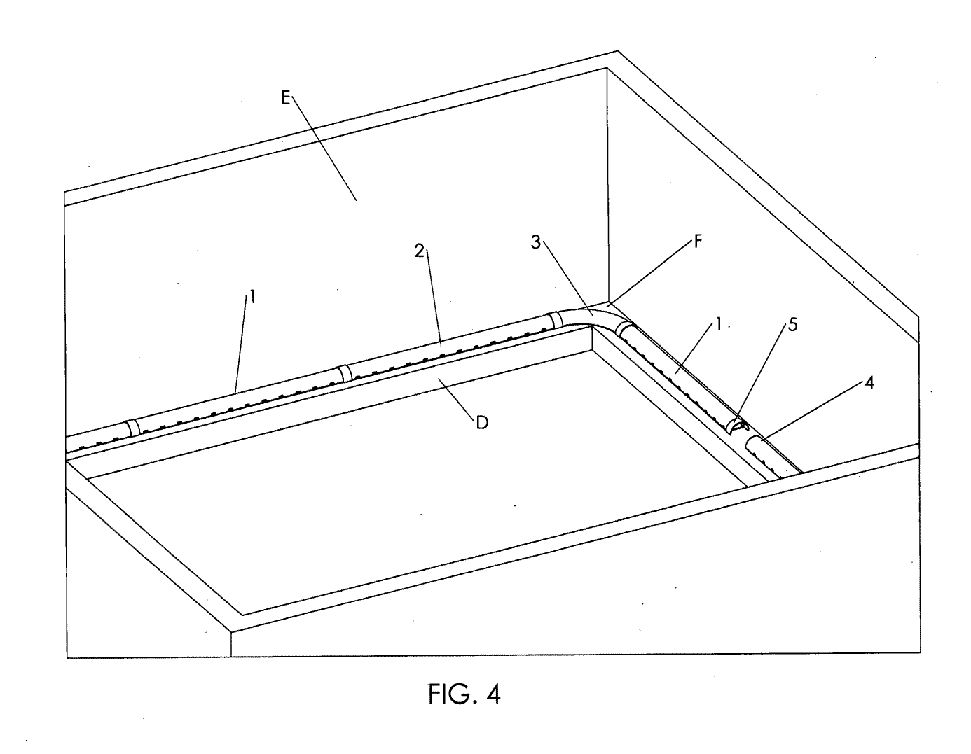

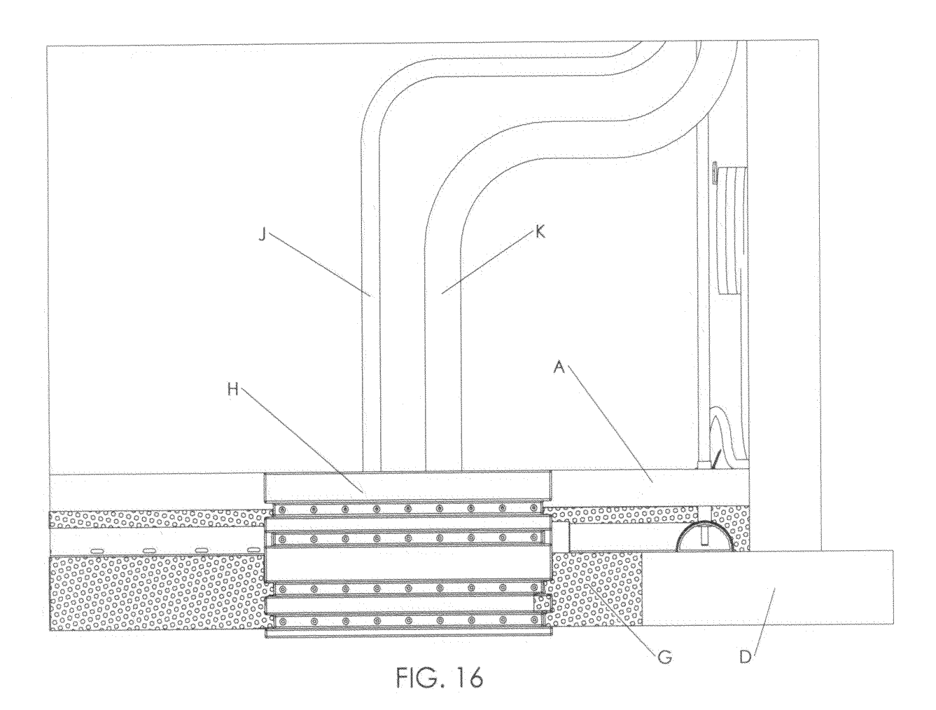

Reference to FIGS. 4 and 16 facilitates an appreciation for how water and/or radon gas seeping into a subflooring portion of a building or structure via joints F as between inner footing D and walling E with respect to FIG. 4, then enters holes 16 in first channeling units 1 and second channeling units 2 to then leach out of channeling units 1 and 2 via holes 16 in the sides of units 1 and 2 opposite the sides thereof adjacent joints F and with reference to FIG. 16, and then leaches into and through medium G, typically crushed rock to where the water and/or gas ultimately enters a pump H to then be pumped to the exterior of the building or structure via piping J and K. Alarm 21 connected via wiring 20 to sensor device 19 is activated when the water level within channeling units 1 and 2 is high enough to trigger the sensor 19 thus indicating a problem with respect to the operability of pump H causing back up of water and/or radon gas within the system. Water under pressure in a hose B which is inserted into hole C in flooring A can, via spout 22 serve to flush the system from time to time of small amounts of debris or sediment built up therein over time whereupon such debris or sediment is then flushed into medium H. The cleansing through hole 18 and spout 22 as is lid 23 are optional features of the system.

In conclusion, respectfully submitted the above described embodiments of the instant invention serve to provide a notably efficient, durable and economical way to facilitate ready evacuation of water and/or radon gas from an area below basement flooring A that is accordingly new, useful and unique.

What is claimed is:

1. A subflooring water and radon gas channeling system, comprising:
a. a plurality of elongated, semi-cylindrically shaped, hollow first channeling units;
b. a plurality of elongated semi-cylindrically shaped, hollow second channeling units;
c. a plurality of curved semi-cylindrically shaped, hollow corner connector units;
d. a first end of each one of said first channeling units;
e. a second end portion of each one of said first channeling units;
f. a bottom side of each one of said first channeling units extending from said first end of said each one to said second end portion of said each one of said first channeling units;
g. a bottom side of each one of said second channeling units extending from a first end of said each one of said second channeling units to a second end of said each one of said second channeling units;
h. a second end radius of each said second end portion being greater in length than a first channeling radius of a whole remainder segment of said each one of said first channeling units and greater in length than a second channeling radius of said each one of said second channeling units;
i. a bottom side of each one of said corner connector units extending from a first end sector of said each one of said corner connector units to a second end sector of said each one of said corner connector units;
j. a first radius of said first end sector of said each one of said corner connector units being equal in length to a second radius of said second end sector of said each one of said corner connector units;
k. said first radius being greater in length than said first channeling radius and greater in length than said second channeling radius;
l. a plurality of holes being located in each side of said each one of said first channeling units and said each one of said second channeling units;
m. said first end of any one of said second channeling units being connected into a said first end sector of any one of said corner connector units;
n. said first end of any one of said first channeling units being connected into a said second end sector of said any one of said corner connector units;
o. said second end of any one of said second channeling units being connected into a said second end portion of said any one of said first channeling units;
p. said first end of any one of said first channeling units being also connectable into a said second end portion of said any other one of said first channeling units;
q. a sensor through hole and separate cleansing through hole being each cut into a highest positioned midline of any one of said first channeling units or said second channeling units;
r. a sensor device held at one end of elongated wiring and receivable by said sensor through hole and located a short distance above any said bottom side of said any one of said first channeling units or said second channeling units;
s. said elongated wiring extending through a hole in basement flooring and being connected at a second end thereof to an alarm unit located at or above a level of said basement flooring, and;
t. an elongated spout mounted to any one of said first channeling units or said second channeling units and being so mounted about said cleansing hole and extending upwardly through a second hole in said basement flooring.

2. The subflooring water and radon gas channeling system of claim 1, whereby a lid is affixed to near a top edge of said spout.

3. A subflooring water and radon gas channeling system, comprising:
a. a plurality of elongated, semi-cylindrically shaped, hollow first channeling units;
b. a plurality of elongated semi-cylindrically shaped, hollow second channeling units;
c. a plurality of curved semi-cylindrically shaped, hollow corner connector units;
d. a first end of each one of said first channeling units;
e. a second end portion of each one of said first channeling units;
f. a bottom side of each one of said first channeling units extending from said first end of said each one to said second end portion of said each one of said first channeling units;
g. a bottom side of each one of said second channeling units extending from a first end of said each one of said second channeling units to a second end of said each one of said second channeling units;
h. a second end radius of each said second end portion being greater in length than a first channeling radius of a whole remainder segment of said each one of said first channeling units and greater in length than a second channeling radius of said each one of said second channeling units;
i. a bottom side of each one of said corner connector units extending from a first end sector of said each one of said corner connector units to a second end sector of said each one of said corner connector units;
j. a first radius of said first end sector of said each one of said corner connector units being equal in length to a second radius of said second end sector of said each one of said corner connector units;
k. said first radius being greater in length than said first channeling radius and greater in length than said second channeling radius;
l. a plurality of holes being located in each side of said each one of said first channeling units and said each one of said second channeling units;
m. said first end of any one of said second channeling units being connected into a said first end sector of any one of said corner connector units;
n. said first end of any one of said first channeling units being connected into a said second end sector of said any one of said corner connector units;
o. said second end of any one of said second channeling units being connected into a said second end portion of said any one of said first channeling units;
p. said first end of any one of said first channeling units being also connectable into a said second end portion of said any other one of said first channeling units;
q. a sensor through hole being cut into a highest positioned midline of any one of said first channeling units or said second channeling units;
r. a sensor device held at one end of elongated wiring and receivable by said sensor through hole and located a short distance above any said bottom side of said any one of said first channeling units or said second channeling units, and;
s. said elongated wiring extending through a hole in basement flooring and being connected at a second end thereof to an alarm unit located at or above a level of said basement flooring.
